(19) United States
(12) Patent Application Publication
(10) Pub. No.: US 2026/0260883 A1
(43) Pub. Date: Sep. 3, 2026

(54) CATHODE ACTIVE MATERIAL FOR SODIUM SECONDARY BATTERY, METHOD OF PREPARING THE SAME, AND SODIUM SECONDARY BATTERY INCLUDING THE SAME

(71) Applicant: Samsung Electronics Co., Ltd., Suwon-si (KR)

(72) Inventors: Soyeon Kim, Suwon-si (KR); Dongrak Sohn, Suwon-si (KR); Jonghoon Ka, Suwon-si (KR); Ryounghee Kim, Suwon-si (KR); Youngsin Park, Suwon-si (KR); Hyunpyo Lee, Suwon-si (KR)

(21) Appl. No.: 19/547,798

(22) Filed: Feb. 24, 2026

(30) Foreign Application Priority Data
Feb. 28, 2025 (KR) 10-2025-0026917

(51) Int. Cl. H01M 4/525; C01G 53/51; H01M 4/02; H01M 4/131; H01M 10/054; H01M 10/0585

(52) U.S. Cl. CPC H01M 4/525; C01G 53/51; H01M 4/131; H01M 10/054; H01M 10/0585; C01P 2002/50; C01P 2002/72; C01P 2004/61; C01P 2006/11; C01P 2006/12; C01P 2006/40; H01M 2004/027; H01M 2004/028

(57) ABSTRACT

A cathode active material for a sodium secondary battery, a method of preparing the cathode active material, and a sodium secondary battery including the cathode active material. The cathode active material includes a layered sodium transition metal oxide having an O3 structure, wherein the layered sodium transition metal oxide includes a compound represented by Formula 1:

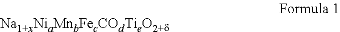

wherein the elemental indices are as described herein.

### CROSS-REFERENCE TO RELATED APPLICATION

This application claims priority to Korean Patent Application No. 10-2025-0026917, filed on Feb. 28, 2025, in the Korean Intellectual Property Office, and all the benefits accruing therefrom under 35 U.S.C. § 119, the disclosure of which in its entirety is incorporated by reference herein.

### BACKGROUND

### 1. Field

The present disclosure relates to a cathode active material for sodium secondary batteries, a method of preparing the cathode active material, and a sodium secondary battery including the cathode active material.

### 2. Description of the Related Art

Recently, there has been active development of batteries providing increased energy density and safety. Sodium batteries may be used in information appliances, communication appliances, automobiles, and energy storage systems. Safety is important because automobiles are related to human life.

Sodium-ion batteries have been successfully commercialized, but additional performance improvements are needed for widespread use. Cathode active materials of sodium secondary batteries may be classified into cathode active materials having an O3 structure and cathode active materials having a P2 structure.

Although cathode active materials having an O3 structure have excellent capacity characteristics, their lifespan performance deteriorates due to complicated phase transitions during a charge-discharge process, and thus improvements thereof are required and are of present interest.

Additionally, methods using nickel, manganese, iron, etc. have been proposed to prepare low-cost cathode active materials. However, when using these metals, it is practically very difficult to prepare cathode active materials having both high energy and excellent lifespan performance, and thus improvements thereof are required and are of present interest.

### SUMMARY

Provided is a cathode active material for a sodium secondary battery with improved structural stability.

Provided is a method of preparing the cathode active material.

Provided is a sodium secondary battery having excellent capacity characteristics and an improved capacity retention rate, including the cathode active material.

Additional aspects will be set forth in part in the description which follows and, in part, will be apparent from the description, or may be learned by practice of the presented embodiments of the disclosure.

According to an aspect of the disclosure, a cathode active material for a sodium secondary battery includes
a layered sodium transition metal oxide having an O3 structure, wherein the layered sodium transition metal oxide includes a compound represented by Formula 1:

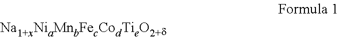

wherein, in Formula 1,
−0.33≤x≤0.1, 0.3≤a≤0.4, 0.3≤b≤0.4, 0≤c≤0.1, d>0, e>0, d>e, a+b+c+d+e=1, and −0.1≤δ≤0.1.

In Formula 1, 0.1≤d≤0.3, and 0.05≤e≤0.1.

In Formula 1, 1<d/e≤3, or 2≤d/e≤3.

In Formula 1, 0.6≤a+b+c≤0.9, and 0.05≤c≤0.1.

According to another aspect of the disclosure, a cathode includes a cathode current collector, and a cathode active material layer disposed on the cathode current collector and containing a cathode active material,
wherein the cathode active material includes a layered sodium transition metal oxide having an O3 structure, and the layered sodium transition metal oxide includes a compound represented by Formula 1:

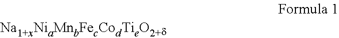

wherein, in Formula 1,
−0.33≤x≤0.1, 0.3≤a≤0.4, 0.3≤b≤0.4, 0≤c≤0.1, d>0, e>0, d>e, a+b+c+d+e=1, and −0.1≤δ≤0.1.

According to another aspect of the disclosure, a sodium secondary battery includes a cathode, an anode, and an electrolyte between the cathode and the anode, wherein the cathode includes a cathode current collector and a cathode active material layer disposed on the cathode current collector and containing a cathode active material, the cathode active material includes a layered sodium transition metal oxide having an O3 structure, and the layered sodium transition metal oxide includes a compound represented by Formula 1:

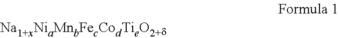

wherein, in Formula 1,
−0.33≤x≤0.1, 0.3≤a≤0.4, 0.3≤b≤0.4, 0≤c≤0.1, d>0, e>0, d>e, a+b+c+d+e=1, and −0.1≤δ≤0.1.

The electrolyte may include a solid electrolyte, a liquid electrolyte, a gel electrolyte, or a combination thereof.

The sodium secondary battery may further include a separator.

According to another aspect of the disclosure, a method of preparing a cathode active material for a sodium secondary battery includes mixing a sodium (Na) precursor, a nickel (Ni) precursor, a manganese (Mn) precursor, a cobalt (Co) precursor, and a titanium (Ti) precursor to prepare a precursor mixture, and
heat-treating the precursor mixture to prepare a cathode active material,
wherein the cathode active material includes a layered sodium transition metal oxide having an O3 structure, and the layered sodium transition metal oxide includes a compound represented by Formula 1:

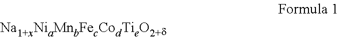

wherein, in Formula 1,
−0.33≤x≤0.1, 0.3≤a≤0.4, 0.3≤b≤0.4, 0≤c≤0.1, d>0, e>0, d>e, a+b+c+d+e=1, and −0.1≤δ≤0.1.

The method may further include preparing a cathode active material precursor using the precursor mixture. The cathode active material precursor may be a compound including a cation and represented by Formula 2:

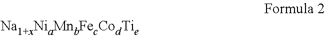

wherein, in Formula 2,
−0.33≤x≤0.1, 0.3≤a≤0.4, 0.3≤b≤0.4, 0≤c≤0.1, d>0, e>0, d>e, a+b+c+d+e=1, and −0.1≤δ≤0.1.

According to another aspect of the disclosure, a cathode for a sodium secondary battery includes a cathode current collector, and a cathode active material layer disposed on the cathode current collector and containing a cathode active material, wherein the cathode active material includes a layered sodium transition metal oxide having an O3 structure, and the layered sodium transition metal oxide includes a compound represented by Formula 1:

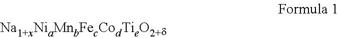

wherein, in Formula 1,
−0.33≤x≤0.1, 0.3≤a≤0.4, 0.3≤b≤0.4, 0≤c≤0.1, d>0, e>0, d>e, a+b+c+d+e=1, and −0.1≤δ≤0.1.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an X-ray diffraction spectrum of a cathode active material prepared according to Example 1;

FIG. 2 illustrates an X-ray diffraction spectrum of a cathode active material prepared according to Comparative Example 1;

FIG. 3A is a graph illustrating voltage changes according to capacity in a sodium secondary battery of Manufacture Example 1;

FIG. 3B is a graph illustrating voltage changes according to capacity in a sodium secondary battery of Manufacture Example 2;

FIG. 3C is a graph illustrating voltage changes according to capacity in a sodium secondary battery of Manufacture Example 3;

FIG. 3D is a graph illustrating voltage changes according to capacity in a sodium secondary battery of Comparative Manufacture Example 1;

FIG. 3E is a graph illustrating voltage changes according to capacity in a sodium secondary battery of Comparative Manufacture Example 2;

FIG. 3F is a graph illustrating voltage changes according to capacity in a sodium secondary battery of Comparative Manufacture Example 3;

FIG. 3G is a graph illustrating voltage changes according to capacity in a sodium secondary battery of Comparative Manufacture Example 4;

FIG. 3H is a graph illustrating voltage changes according to capacity in a sodium secondary battery of Comparative Manufacture Example 5;

FIG. 3I is a graph illustrating a voltage change according to capacity in a sodium secondary battery of Comparative Manufacture Example 6;

FIG. 3J is a graph illustrating voltage changes according to capacity in a sodium secondary battery of Comparative Manufacture Example 7;

FIG. 3K is a graph illustrating voltage changes according to capacity in a sodium secondary battery of Comparative Manufacture Example 8;

FIG. 4 illustrates the capacity retention characteristics of coin cells of Manufacture Examples 1 to 3 having cathodes containing cathode active materials of Examples 1 to 3 and coin cells of Comparative Manufacture Examples 1 to 8 having cathodes containing cathode active materials of Comparative Examples 1 to 8;

FIG. 5 is a view for explaining a sodium secondary battery according to an embodiment;

FIG. 6 is a cross-sectional view of a sodium solid secondary battery according to an embodiment; and

FIG. 7 is a cross-sectional view of a sodium solid secondary battery according to another embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

Various embodiments are illustrated in the attached drawings. However, the present inventive concept may be embodied in many different forms and should not be construed as limited to the embodiments described herein. Rather, these embodiments are provided so that the disclosure will be made thoroughly and completely, and will fully transfer the scope of the present inventive concept to those skilled in the art.

When a component is referred to as being “over” or “on” another component, it may be understood that it may be directly on another component, or that there may be other components intervening therebetween. In contrast, when a component is referred to as being “directly on” another component, there is no intervening component therebetween.

The terms “first,” “second,” “third,” etc. may be used herein to describe various components, ingredients, regions, layers and/or zones, but these components, ingredients, regions, layers and/or zones should not be limited by these terms. These terms are used only to distinguish one component, ingredient, region, layer or zone from another component, ingredient, region, layer or zone. Accordingly, a first component, ingredient, region, layer or zone described below may be referred to as a second component, ingredient, region, layer or zone without departing from the teachings of the present specification.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. Therefore, reference to “an” element in a claim followed by reference to “the” element is inclusive of one element as well as a plurality of the elements.

“At least one” is not to be construed as limiting “a” or “an.” “Or” means “and/or.” As used herein, the term “and/or” includes any and all combinations of one or more of the associated listed items.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by those skilled in the art to which this disclosure belongs. It will also be understood that terms defined in commonly used dictionaries should be interpreted to have a meaning consistent with their meaning within the context of the relevant art and the present disclosure, and not in an idealized or overly formal sense.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value.

Exemplary embodiments are described herein with reference to cross-sectional views which are schematic views of idealized embodiments. Likewise, variations in illustrated shapes must be expected as a result of manufacturing techniques and/or tolerances. Therefore, the embodiments described herein should not be construed as limited to the specific shapes of regions as illustrated herein, but should include deviations in shapes resulting from, for example, manufacturing. For example, a region illustrated or described as flat may typically have rough and/or non-linear features. Moreover, sharply illustrated angles may be round. Accordingly, the regions illustrated in the drawings are schematic in nature, and their shapes are not intended to illustrate the precise shape of the regions and are not intended to limit the scope of the present claims.

“Group” refers to a group in the periodic table of the elements according to the International Union of Pure and Applied Chemistry (“IUPAC”) Group 1 to 18 classification system.

As used herein, the term “particle diameter” refers to an average diameter when particles are spherical, and refers to an average major axis length when the particles are non-spherical. The particle diameter may be measured using a particle size analyzer (PSA). The “particle diameter” refers to an average particle diameter. The “average particle diameter” refers to, for example, a median particle diameter (D50). D50, D90, and D10 are sizes of particles corresponding to 50%, 90%, and 10% of cumulative volume, respectively, calculated from particles having a smaller particle size in the particle size distribution measured by laser diffraction.

The “metal” as used herein refers to both metals and metalloids such as silicon and germanium, in an elemental or ionic state.

The “positive electrode” or “cathode” used herein refers to an electrode in which electrochemical reduction and sodiation occur during a discharge process, and the “negative electrode” or “anode” used herein refers to an electrode in which electrochemical oxidation and desodiation occur during a discharge process.

In addition, in the present application specification, “mol %” is interpreted to mean the content of any metal included in the cathode active material or cathode active material precursor, assuming that the molar ratio of the remaining metals excluding sodium and oxygen in the cathode active material or cathode active material precursor is 100%.

Although specific embodiments have been described, alternatives, modifications, variations, improvements, and substantial equivalents which are not currently anticipated or cannot be anticipated may occur to the applicant or those skilled in the art. Accordingly, the appended claims, as filed and as amended, are intended to include all such alternatives, modifications, variations, improvements and substantial equivalents.

As used herein, the thickness refers to an average thickness, and may be confirmed using a scanning electron microscope or a transmission electron microscope.

Hereinafter, a composite solid electrolyte according to an embodiment, a method for preparing the composite solid electrolyte, and a lithium battery including the composite solid electrolyte will be described in more detail.

Hereinafter, a positive electrode active material for a sodium secondary battery, a method for manufacturing the same, and a sodium secondary battery using the same according to embodiments will be described in more detail.

A cathode active material having an O3 structure has excellent capacity characteristics, but its lifespan performance may deteriorate due to complicated phase transition during a charge-discharge process.

A cathode active material for sodium secondary batteries according to an embodiment may have excellent capacity characteristics and improved lifespan performance while ensuring structural stability by solving the above-described problems. Such a cathode active material for sodium secondary batteries may include a layered sodium transition metal oxide having an O3 structure, wherein the layered sodium transition metal oxide includes a compound represented by Formula 1 below:

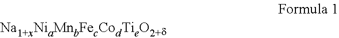

wherein, in Formula 1,
−0.33≤x≤0.1, 0.3≤a≤0.4, 0.3≤b≤0.4, 0≤c≤0.1, d>0, e>0, d>e, a+b+c+d+e=1, and −0.1≤δ≤0.1.

In Formula 1, 1+x is about 0.67 to about 1.1, about 0.7 to about 1.1, about 0.8 to about 1.1, about 0.9 to about 1.1, or about 1.0 to about 1.1.

In the cathode active material according to an embodiment, when the content of sodium is within the above range, the O3 structure may be or remain stable over an extended period of time, and when the content of sodium is outside the above range, it becomes difficult to maintain the stability of the O3 structure.

The content of nickel in the cathode active material may be about 30 mol % to about 40 mol %, about 31 mol % to about 39 mol %, about 32 mol % to about 39 mol %, or about 33 mol % to about 38 mol %, based on 100 mol % of the sum of the remaining metals excluding sodium and oxygen. When the content of nickel is within the above range, a cathode active material having excellent capacity characteristics may be prepared or obtained. If the content of nickel more than 40 mol %, the manufacturing cost of the cathode active material will likely increase, and if the content of nickel is less than 30 mol %, the capacity of the cathode active material may decrease due to a low nickel content. Moreover, if the content of nickel is excessively increased (for example, 60% or more) to increase the capacity of the cathode active material, both the capacity and lifespan performance of the cathode active material may decrease due to side reactions between highly reactive Ni⁴⁺ and an electrolyte.

The content of manganese in the cathode active material may be about 30 mol % to about 40 mol %, about 31 mol % to about 40 mol %, about 32 mol % to about 39 mol %, or about 33 mol % to about 38 mol % based on 100 mol % of the sum of all metals excluding sodium and oxygen in the material. Manganese contributes to maintaining the stability of a crystal structure over a wide voltage range, thereby helping to improve the lifespan of the cathode active material. If the content of manganese having a +4 valent oxidation number is increased excessively (for example, 50% or more of the Mn present), synthesis may proceed in a P2 phase with a low sodium content. In Formula 1, 0.6≤a+b+c≤0.9, and 0.05≤c≤0.1.

In the cathode active material according to an embodiment, the total content of nickel, manganese, and iron is about 60 mol % to about 90 mol %, about 63 mol % to about 90 mol %, about 65 mol % to about 90 mol %, or about 70 mol % to about 85 mol %, based on 100 mol % of the sum of the remaining metals excluding sodium and oxygen. Additionally, the content of iron may be 10 mol % or less, about 1 mol % to about 10 mol %, about 3 mol % to about 10 mol %, or about 5 mol % to about 10 mol %, based on 100 mol % of the sum of the remaining metals excluding sodium and oxygen.

In the cathode active material, when the total content of nickel, manganese and iron and the content of iron are within the above ranges, the average operating voltage may be improved, the capacity may be increased, and the stability of the cathode active material to the atmosphere may be improved.

In Formula 1, 0.1≤d≤0.3, 0.15≤d≤0.3, or 0.2≤d≤0.3.

In the cathode active material represented by Formula 1, when the content of cobalt is about 10 mol % to about 30 mol % based on 100 mol % of the sum of the remaining metals excluding sodium and oxygen, the cathode active material has high conductivity and structural stability, and a sodium secondary battery having an improved capacity retention rate and rate characteristics may be manufactured when using this cathode active material as described herein.

In Formula 1, 0.05≤e≤0.1, 0.06≤e≤0.1, 0.07≤e≤0.1, or 0.08≤e≤0.1.

The cathode active material represented by Formula 1 contains titanium, and Because titanium has lower electronegativity than manganese and has increased bonding force to oxygen, structural stability of the cathode active material containing titanium may be improved compared to that of a cathode active material that does not contain titanium. When the content of titanium in the cathode active material is about 5 mol % to about 10 mol %, the cathode active material may have high conductivity and structural stability, and a sodium secondary battery having an improved capacity retention and rate characteristics may be manufactured when using the cathode active material as described herein.

In Formula 1, 1≤d/e≤3, or 2≤d/e≤3. When the molar ratio of titanium and cobalt is within the above range, a cathode active material having maximized structural stability and improved capacity and capacity retention rate may be manufactured. If the content of titanium in the positive electrode active material is greater than that of cobalt, the structural stability of the cathode active material may be improved by suppressing the phase transition of the cathode active material, but the initial capacity thereof may be reduced.

In Formula 1, δ is a value determined to satisfy the charge neutrality condition of the cathode active material, and is determined according to the oxidation number and element ratio of the elements and their corresponding oxidation states. For example, δ is 0. Here, the oxidation number and the element ratio may be determined by, for example, X-ray spectroscopy (XRD), X-ray photoelectron spectroscopy (XPS), energy dispersive x-ray spectroscopy (EDX), or the like.

The compound represented by Formula 1 may be, for example, NaNi_{0.3}Mn_{0.3}Fe_{0.1}Co_{0.2}Ti_{0.1}O₂, NaNi_{0.3}Mn_{0.3}Co_{0.3}Ti_{0.1}O₂, NaNi_{0.4}Mn_{0.4}Fe_{0.05}Co_{0.1}Ti_{0.05}O₂, NaNi_{0.4}Mn_{0.3}Co_{0.2}Ti_{0.1}O₂, or NaNi_{0.35}Mn_{0.35}Co_{0.2}Ti_{0.1}O₂.

In a sodium secondary battery employing a cathode including the cathode active material, a 0.1 C rate capacity of a sodium metal in a voltage range of about 2.0 V to about 4.0 V is about 125 milliampere per gram (mAh/g) to about 140 mAh/g or about 129 mAh/g to about 1380 mAh/g, and a capacity retention rate may be 90% or more, 90% or more, about 90% to about 99%, or about 92% to about 99%, after 50 charge-discharge cycles at a constant current of 0.1 C rate. In this way, the cathode active material according to an embodiment may have improved initial capacity and capacity retention characteristics.

The composition of the cathode active material according to an embodiment may be confirmed through structural analysis (XRD analysis and transmission electron microscope (TEM) analysis) and component analysis (inductively coupled plasma spectrometry (ICP)).

The average particle diameter of the cathode active material may be about 1 micrometer (μm) to about 20 μm, about 1 μm to about 18 μm, or about 2 μm to about 12 μm. When the average particle diameter of the cathode active material is within the above range, a sodium secondary battery having improved capacity and capacity retention rate may be manufactured.

The BET specific surface area of the cathode active material according to an embodiment may be about 0.2 meters squared per gram (m²/g) to about 5 m²/g, or about 0.5 m²/g to about 1.5 m²/g. The tap density of the cathode active material may be about 1.0 grams per cubic centimeter (g/cm³) to about 3.5 g/cm³, or about 1.0 g/cm³ to about 3.0 g/cm³. When the specific surface area and tap density of the cathode active material are within the above ranges, a sodium secondary battery having excellent capacity characteristics and improved capacity retention may be manufactured.

In a powder X-ray diffraction pattern of the cathode active material according to an embodiment, the cathode active material may have three to five diffraction peaks, for example, four diffraction peaks, in a region where a diffraction angle 2θ is 30° to 40°, and the four diffraction peaks may appear in regions where the diffraction angle 2θ is 33°, 35°, and 36°.

In addition, the cathode active material may have a diffraction peak (a first peak) in a region where the diffraction angle 2θ is about 40° to about 45° or in a region where the diffraction angle 2θ is 42°, and a diffraction peak (a second peak) in a region where the diffraction angle 2θ is about 15° to about 18° or in a region where the diffraction angle 2θ is about 17°.

The intensity (Ia) of the first peak at a diffraction angle 2θ of 42° may be greater than the intensity (Ib) of the second peak at a diffraction angle 2θ of 17°. Here, the ratio of the intensity (Ia) of the first peak at a diffraction angle 2θ of 42° to the intensity (Ib) of the second peak at a diffraction angle 2θ of 17° may be about 1:0.7 to about 1:0.8. The cathode active material having such diffraction peak characteristics may provide a stable channel for transport of sodium ions, and therefore, provide a sodium secondary battery having an improved initial efficiency and capacity retention rate.

Hereinafter, a method of preparing the cathode active material according to an embodiment will be described.

A first embodiment of the method of preparing the cathode active material for sodium secondary batteries is as follows.

First, a sodium (Na) precursor, a nickel (Ni) precursor, a manganese (Mn) precursor, a cobalt (Co) precursor, and a titanium (Ti) precursor are mixed to provide or prepare a precursor mixture. Here, the mixing may use solid mixing or liquid mixing. In the solid mixing, mechanical milling may be performed by using a ball mill. In the liquid mixing, an organic solvent may be used.

The mixing ratio of a sodium (Na) precursor, a nickel (Ni) precursor, a manganese (Mn) precursor, a cobalt (Co) precursor, and a titanium (Ti) precursor may be controlled to a stoichiometric content corresponding to the composition of Formula 1. For example, the mixing ratio of a sodium (Na) precursor, a nickel (Ni) precursor, a manganese (Mn) precursor, a cobalt (Co) precursor, and a titanium (Ti) precursor may be controlled by the corresponding mole amounts of each precursor, thereby providing a mole ratio of each element with respect to a total moles of all the element precursor, or in some instances, a mole ratio to another precursor element.

An iron (Fe) precursor may be added to the precursor mixture. Here, the content of the iron (Fe) precursor may be controlled by a stoichiometric content corresponding to the composition of Formula 1. Further, the mixing ratio of the iron (Fe) precursor may be controlled by a molar ratio of each element.

Following the providing for or the preparation of the precursor mixture, the precursor mixture may be heat-treated to prepare a cathode active material.

The cathode active material may include a layered sodium transition metal oxide having an O3 structure, and the layered sodium transition metal oxide may include a compound represented by Formula 1 below:

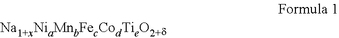

wherein, in Formula 1,
−0.33≤x≤0.1, 0.3≤a≤0.4, 0.3≤b≤0.4, 0≤c≤0.1, d>0, e>0, d>e, a+b+c+d+e=1, and −0.1≤δ≤0.1.

In Formula 1, 1+x may be about 0.67 to about 1.1, about 0.7 to about 1.1, about 0.8 to about 1.1, about 0.9 to about 1.1, or about 1.0 to about 1.1.

The heat treatment may be performed at about 600° C. to about 1,000° C., about 650° C. to about 1,000° C., about 700° C. to about 1,000° C., or about 800° C. to about 950° C. When the heat treatment is performed within the above-described temperature range, a cathode active material having an excellent capacity and an improved capacity retention rate may be manufactured. If the heat treatment temperature is lower than 600° C., the temperature may be lower than the melting point of one or more metals included in the cathode active material, so unreacted metal particles may remain, and if the heat treatment temperature is higher than 1000° C., the ratio of elements constituting the cathode active material may become difficult to control during preparation, thereby deteriorating the lifespan performance of a sodium secondary battery including the cathode active material.

The heat treatment may be performed in an inert gas atmosphere or an oxidizing gas atmosphere. Here, the inert gas atmosphere may be carried out under nitrogen or helium gas, and the oxidizing gas atmosphere may be carried out under air or atmosphere.

According to a second embodiment of the method of preparing the cathode active material, the precursor mixture is prepared, and then a cathode active material precursor may be prepared using the precursor mixture.

The cathode active material precursor may include a chloride containing a cation represented by Formula 2, a nitrate containing a cation represented by Formula 2, an acetate containing a cation represented by Formula 2, a hydroxide containing a cation represented by Formula 2, a carbonate containing a cation represented by Formula 2 below, a sulfate containing a cation represented by Formula 2, a phosphate containing a cation represented by Formula 2, an oxalate containing a cation represented by Formula 2, or an oxide containing a cation represented by Formula 2.

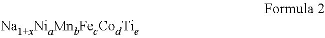

In Formula 2, −0.33≤x≤0.1, 0.3≤a≤0.4, 0.3≤b≤0.4, 0≤c≤0.1, d>0, e>0, d>e, and a+b+c+d+e=1.

In Formula 2, 1+x may be about 0.7 to about 1.1, about 0.8 to about 1.1, about 0.9 to about 1.1, or about 1.0 to about 1.1.

In Formula 2, 0.1≤d≤0.3 and 0.05≤e≤0.1.

In Formula 2, 1≤d/e≤3, or 2≤d/e≤3.

In Formula 2, 0.6≤a+b+c≤0.9, and 0.05≤c≤0.1.

The process of preparing a cathode active material precursor using the above-described precursor mixture may be performed by a solid-state or liquid-state reaction. The solid-state reaction may be carried out, for example, by mechanical milling, and the liquid-state reaction may be carried out, for example, by coprecipitation.

Mechanical milling may include, for example, high-energy mechanical milling (HEMM).

High-energy mechanical milling can atomize powder by applying high energy to reactants through high rotational force and can also induce a chemical reaction in the reactants through maximized diffusion between powder particles. Further, high-energy mechanical milling may be achieved using a mechanofusion device or a novirta device, and mechanofusion may be a method of forming a mixture by a strong physical rotational force in a dry state and is a method of forming an electrostatic bond between constituent materials. Through this process, a fine particle powder having uniform distribution characteristics may be obtained.

High-energy mechanical milling, for example, high-energy ball milling, and high-energy ball milling may be performed by any known ball milling device used for high-energy ball milling, such as a vibratory mill, a Z-mill, a planetary ball-mill, an attrition mill, a SPEX mill, a low-temperature crusher, a friction mill, a shaker mill, a stirred ball mill, a mixer ball mill, a vertical and horizontal attritor, or the like.

Then, the cathode active material precursor may be heat-treated to prepare a cathode active material for sodium secondary batteries. The heat treatment conditions may vary depending on the type of the cathode active material precursor, but may be applied in the same manner as the heat treatment conditions of the first method of preparing the above-described cathode active material.

A third embodiment of the method of preparing the cathode active material according to an embodiment is as follows.

First, a Na precursor, a Ni precursor, a Mn precursor, a Co precursor, and a Ti precursor are mixed to prepare a precursor mixture. An Fe precursor may be added to the precursor mixture. Here, the content of the Fe precursor may be controlled by a stoichiometric content corresponding to the composition of Formula 1. Further, the mixing ratio of the Fe precursor may be controlled by the molar ratio of each element.

Second, a cathode active material precursor containing a cation represented by Formula 2-1 is prepared by using the precursor mixture:

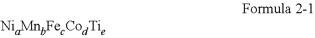

wherein, in Formula 2-1, 0.3≤a≤0.4, 0.3≤b≤0.4, 0≤c≤0.1, d>0, e>0, d>e, a+b+c+d+e=1, and −0.1≤δ≤0.1.

Third, the cathode active material precursor and a Na precursor may be heat-treated to prepare a cathode active material according to an embodiment. The process of preparing the cathode active material precursor using the precursor mixture may be applied in the same manner as the method of preparing the above-described second cathode active material.

In

$$0.1 \leq d \leq 0.3 and 0.05 \leq e \leq 0.1 . \qquad Formula 2 - 1 ,$$

$$1 \leq d / e \leq 3 , or 2 \leq d / e \leq 3. \qquad Formula 2 - 1 ,$$

$$0.6 \leq a + b + c \leq 0.9 , and 0.05 \leq c \leq 0.1 . \qquad Formula 2 - 1 ,$$

The cathode active material precursor containing a cation represented by Formula 2-1 may include, for example, a chloride containing a cation represented by Formula 2-1, a nitrate containing a cation represented by Formula 2-1, an acetate containing a cation represented by Formula 2-1, a hydroxide containing a cation represented by Formula 2-1, a carbonate containing a cation represented by Formula 2-1, a sulfate containing a cation represented by Formula 2-1, a phosphate containing a cation represented by Formula 2-1, an oxalate containing a cation represented by Formula 2-1, or an oxide containing a cation represented by Formula 2-1.

The mixing ratio of the cathode active material precursor and the sodium precursor is controlled by a stoichiometric content corresponding to the composition of Formula 1. For example, the sodium precursor may be used in an amount of 0.67 moles to 1.1 moles, 0.8 moles to 1.1 moles, or 0.9 moles to 1.1 moles per mole of the cathode active material precursor.

In the above-described method of preparing the cathode active material, the sodium precursor may include, for example, NaNO₃, Na₂CO₃, NaOH, CH₃COONa, NaH₂PO₄, Na₃PO₄:12H₂O, Na₂HPO₄, or a combination thereof. The manganese precursor may include manganese chloride, manganese sulfate, manganese oxide, or a combination thereof.

The iron precursor may include Fe(NO₃)₃·9H₂O, FeC₂O₄·2H₂O, or a combination thereof.

The cobalt (Co) precursor and the titanium (Ti) precursor may each include, for example, nitrate, acetates, hydroxides, carbonates, sulfates, phosphates, oxalates, or oxides, each of which contains cobalt and titanium.

According to another aspect of the disclosure, a cathode for sodium secondary batteries includes: a cathode current collector; and a cathode active material layer disposed on the cathode current collector and containing a cathode active material,
wherein the cathode active material includes a layered sodium transition metal oxide having an O₃ structure, and the layered sodium transition metal oxide includes a compound represented by Formula 1:

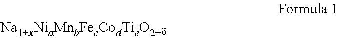

wherein, in Formula 1,
−0.33≤x≤0.1, 0.3≤a≤0.4, 0.3≤b≤0.4, 0≤c≤0.1, d>0, e>0, d>e, a+b+c+d+e=1, and −0.1≤δ≤0.1.

In Formula 1, 1+x may be about 0.67 to about 1.1, about 0.7 to about 1.1, about 0.8 to about 1.1, about 0.9 to about 1.1, or about 1.0 to about 1.1.

In Formula 1, 0.6≤a+b+c≤0.9, and 0.05≤c≤0.1.

In Formula 1, 0.1≤d≤0.3, 0.15≤d≤0.3, or 0.2≤d≤0.3.

In Formula 1, 0.05≤e≤0.1, 0.06≤e≤0.1, 0.07≤e≤0.1, or 0.08≤e≤0.1.

In Formula 1, 1≤d/e≤3, or 2≤d/e≤3.

### [Sodium Secondary Battery]

A sodium secondary battery according to another aspect of the disclosure includes: a cathode; an anode; and an electrolyte between the cathode and the anode, wherein the cathode includes a cathode current collector and a cathode active material layer disposed on the cathode current collector, and the cathode active material layer includes a cathode active material as described herein.

The sodium secondary battery may be a sodium ion battery or a sodium all-solid-state battery. The capacity and lifespan performance of the sodium secondary battery may be improved by including the above-described cathode active material. Hereinafter, the battery will be described in more detail.

Sodium secondary batteries may be used as power sources for solar power generation systems, power systems, energy storage systems, mobile memory devices, or electric vehicles.

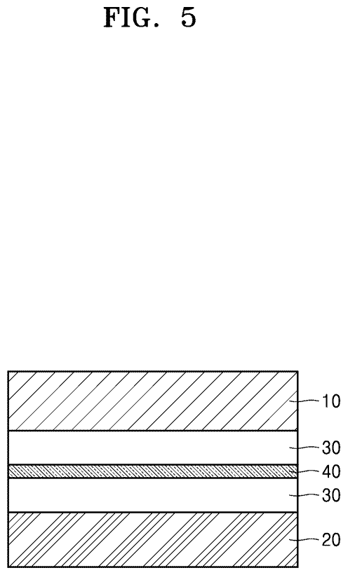

FIG. 5 is a view for explaining a sodium secondary battery according to an embodiment. Referring to FIG. 5, a sodium secondary battery may include an anode 20, a cathode 10 including a cathode active material, an electrolyte 30, and a separator 40.

The cathode 10 may include a cathode active material for secondary batteries according to an embodiment.

The cathode active material may include a cathode active material according to an embodiment.

The cathode 10 may contain a binder and a conductive material in addition to the cathode active material. The cathode 10 may be manufactured by preparing a composition for forming a cathode active material layer, the composition including a cathode active material, a conductive material, and a binder, providing or applying the composition on a cathode current collector, and drying the composition.

The binder and the conductive material may be applied in the same manner as the binder and conductive material of a sodium solid secondary battery to be described later, so descriptions thereof will be omitted.

The anode 20 may include a sodium metal, a sodium alloy, a sodium intercalating compound, a carbon-based material, or a combination thereof.

The anode 20 may include an anode current collector and an anode active material layer disposed on the anode current collector, and the anode active material layer may include an anode active material and a binder. The anode active material may include a carbon-based anode active material, a metal-based anode active material, or a combination thereof.

The carbon-based anode active material may include amorphous carbon, crystalline carbon, porous carbon or a combination thereof, and the metal-based anode active material may include gold (Au), platinum (Pt), palladium (Pd), silicon (Si), silver (Ag), aluminum (Al), bismuth (Bi), tin (Sn), zinc (Zn), or a combination thereof.

The anode 20 may be the same as the anode 20 of a sodium solid battery to be described later, so a description thereof will be omitted.

The separator 40 may be disposed between the cathode 10 and the anode 20. The separator 40 may include at least one selected from microporous films made of a glass fiber, a polyolefin-based resin, a fluorine-based resin, a polyester-based resin, a polyacrylonitrile resin, or a cellulose-based material, or may be a film coated with inorganic particles such as ceramic particles.

The polyolefin-based resin may include polyethylene, polypropylene, or the like, the fluorine-based resin may include polyvinylidene fluoride, polytetrafluoroethylene, or the like, and the polyester-based resin may include polyethylene terephthalate, polybutylene terephthalate, or the like.

The separator may additionally contain additives such as non-conductive particles, other fillers, and fiber compounds for the purpose of controlling strength, hardness, and thermal shrinkage.

When using the separator coated with inorganic particles, the oxidation resistance of the separator may be improved, and the deterioration of battery characteristics may be suppressed. The inorganic particles may include, for example, alumina (Al₂O₃), silica (SiO₂), titania (TiO₂), or a combination thereof. Further, the average particle diameter of the inorganic particles may be about 10 nanometers (nm) to about 5 μm. When the average particle diameter of the inorganic particles is less than 10 nm, the crystallinity of the inorganic particles may deteriorate. When the average particle diameter is greater than 5 μm, dispersion of the inorganic particles may be difficult.

The separator may have a multilayer structure including one or more polymer layers for the purpose of increasing tensile strength or mechanical strength. For example, the multilayer structure may be a polyethylene/polypropylene laminate, a polyethylene/polypropylene/polyethylene laminate, a nonwoven/polyolefin laminate, or the like.

The electrolyte 30 may exist in a state of being impregnated in the separator 40, the cathode 10, or the anode 20. The electrolyte 30 may be a liquid electrolyte, a gel electrolyte, or a combination thereof.

The liquid electrolyte may contain an ionic liquid, a sodium salt, an organic solvent, or a combination thereof. The liquid electrolyte may be, for example, a mixture of an ionic liquid, a sodium salt and an organic solvent; a mixture of an ionic liquid and an organic solvent; or a mixture of a sodium salt, an ionic liquid and an organic solvent.

The organic solvent may be, for example, propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether, or a mixture thereof.

The Ionic liquid refers to a salt that has a melting point below room temperature, is composed only of ions, and is liquid at room temperature, or refers to a molten salt at room temperature. The ionic liquid may include at least one selected from compounds including a) at least one cation selected from ammonium, pyrrolidinium, pyridinium, pyrimidinium, imidazolium, piperidinium, pyrazolium, oxazolium, pyridazinium, phosphonium, sulfonium, triazolium, and mixtures thereof, and b) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

Any sodium salt that may be used as the sodium salt in the relevant technical field is possible. Examples of the sodium salt may include NaClO₄, NaPF₆, NaBF₄, NaSbF₆, NaAsF₆, NaCF₃SO₃, Na(CF₃SO₂)₂N, NaC₄F₉SO₃, NaAlO₂, NaAlCl₄, NaN(CₓF₂ₓ₊₁SO₂)(C_{y}F_{2y+1}SO₂) (x and y are each 1 to 20), NaCl, NaI, NaTFSI (TFSI=bis(trifluoromethane) sulfonimide), NaFSI (FSI=bis(fluorosulfonyl)imide), NaDFOB (DFOB=difluoro (oxalato) borate), NaBOB (bis(oxalato) borate), or mixtures thereof.

The gel electrolyte that may be used as an electrolyte is, for example, a polymer gel electrolyte. The polymer gel electrolyte may include a liquid electrolyte and a polymer, or may include an organic solvent and a polymer having an ion-conducting functional group. The liquid electrolyte used in the polymer gel electrolyte is the same as the above-described liquid electrolyte, so a description thereof will be omitted.

A solid sodium secondary battery will be described with the attached drawings.

A solid secondary battery according to an embodiment may contain a liquid electrolyte. The liquid electrolyte may contain an organic solvent, a sodium salt, an ionic liquid, or a combination thereof.

A solid secondary battery according to another embodiment may be, for example, an all-solid-state secondary battery.

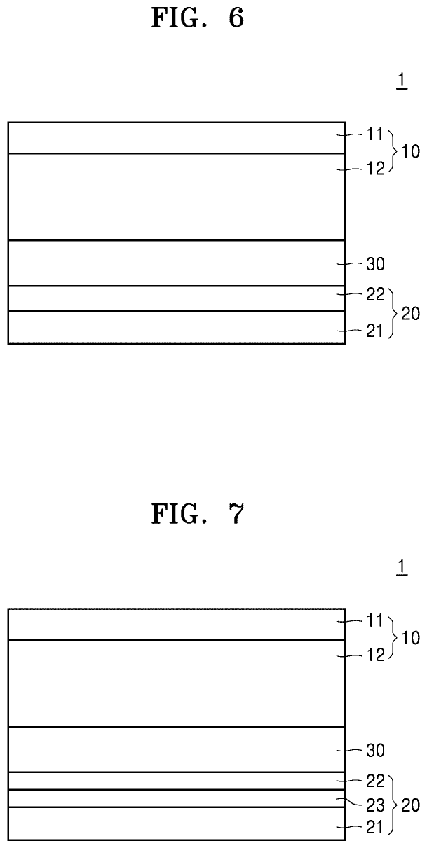

FIGS. 6 and 7 each schematically illustrate the structures of a solid sodium secondary battery according to an embodiment.

Referring to FIGS. 6 and 7, a solid sodium secondary battery 1 includes a cathode 10, an anode 20, and an electrolyte 30 between the cathode 10 and the anode 20. Here, the electrolyte 30 may include a solid electrolyte layer.

The cathode 10 includes a cathode current collector 11 and a cathode active material layer 12, and the anode 20 includes an anode current collector 21 and an anode active material layer 22. The cathode active material layer 12 may contain a cathode active material according to an embodiment.

The electrolyte 30 may include a solid electrolyte, and the solid electrolyte may further include a sulfide-based solid electrolyte, an oxide-based solid electrolyte, or a combination thereof.

The sulfide-based solid electrolyte may have a crystalline structure, and may include, for example, an argyrodite type solid electrolyte.

The sulfide-based solid electrolyte may include, for example, Na₃PS₄, Na₃₋ₓPS₄₋ₓClₓ (0<x<3), Na₃₋ₓP₁₋ₓWₓS₄ (0≤x≤1), Na₃PS₄ₓOₓ (0<x<4), Na₃₋₂ₓCaₓPS₄ (0<x<1.5), Na₃SbS₄, Na₃₋ₓSb₁₋ₓWₓS₄ (0≤x<1), Na_{2.88}Sb_{0.88}W_{0.12}S₄₋ₓNaI (0<x<1), Na₃WₓSiₓSb₁₋₂ₓS₄ (0≤x<0.5), Na_{3- x}Sb₁₋ₓWₓS₄₋₃ₓO₃ₓ, (0≤x<1), Na₃SbS₄—Na₂WₓS₄I₆ₓ₋₄ (0≤x<1), Na₂S—P₂S₅, Na₂S—P₂S₅—NaX (X=F, Cl, Br, I), Na₂S—P₂S₅—Na₂O, Na₂S—P₂S₅—Na₂O—NaI, Na₂S—SiS₂, Na₂S—SiS₂—NaI, Na₂S—SiS₂—NaBr, Na₂S—SiS₂—NaCl, Na₂S—SiS₂—B₂S₃—NaI, Na₂S—SiS₂—P₂S₅—NaI, Na₂S—B₂S₃, Na₂S—P₂S₅—ZmSn, (0<m≤10, 0<n≤10, Z=Ge, Zn or Ga), Na₂S—GeS₂, Na₂S—SiS₂—Na₃PO₄, Na₂S—SiS₂—NaₚMO_{q} (0<p≤10, 0<q≤10, M=P, Si, Ge, B, Al, Ga or In), Na₇₋ₓPS₆₋ₓClₓ (0≤x≤2), Na₇₋ₓPS₆₋ₓBrₓ (0≤x≤2), Na₇₋ₓPS₆₋ₓIₓ (0≤x≤2), Na₁₀MP₂S₁₂ (M=Ge, Si, or Sn), or a combination thereof. Further, the sulfide-based solid electrolyte may have a crystalline, amorphous, glassy, or glass-ceramic state.

The oxide-based solid electrolyte may include, for example, NaₐM1_{b}M2_{c}O_{d}, (M1=Al, Y, Yb, Nd, Nb, Ti, Hf, M2=Si, P, 1≤a≤6 1≤b≤3, 2≤c≤5 5≤d≤15), Na₁₊ₓZr₂SiₓP₃₋ₓO₁₂ (0≤x≤3), NaₓM₂(PO₄)₃ (M=V or Ti; 0≤x≤3), Na₃₊ₓLa_{(2/3-x)(1/3-2x)}TiO₃ (0.04<x<0.16), Na₁₊ₓAlₓTi₂₋ₓ(PO₄)₃ (0<x<2), Na₁₊ₓAlₓGe₂₋ₓ(PO₄)₃ (0<x<2), Na_{1+x+y}AlₓTi₂₋ₓSi_{y}P_{3-y}O₁₂ (0<x<2, 0≤y<3), BaTiO₃, Pb(Zr, Ti)O₃, Pb₁₋ₓLaₓZr_{1-y}Ti_{y}O₃ (0≤x<1, 0≤y<1), Pb(Mg_{1/3}Nb_{2/3})O₃—PbTiO₃, Na₃PO₄, NaₓTi_{y}(PO₄)₃ (0<x<2, 0<y<3), NaₓAl_{y}Ti_{z}(PO₄)₃ (0<x<2, 0<y<1, 0<z<3), Na_{1+x+y}(Al, Ga)ₓ(Ti, Ge)₂₋ₓSi_{y}P_{3-y}O₁₂ (0≤x≤1 0≤y≤1), NaₓLa_{y}TiO₃ (0<x<2, 0<y<3), Na₂O, NaOH, Na₂CO₃, NaAlO₂, Na₂O—Al₂O₃—SiO₂—P₂O₅—TiO₂—GeO₂, Na₃₊ₓLa₃M₂O₁₂ (M=Te, Nb or Zr, 1≤x≤10), Na₇La₃Zr₂O₁₂, Na₃₊ₓLa₃Zr₂₋ₐMₐO₁₂, (M=Ga, W, Nb, Ta, or Al, 0<a<2, 1≤x≤10), or a combination thereof. The oxide-based solid electrolyte may be, for example, a NASICON solid electrolyte represented by Na₁₊ₓZr₂SiₓP₃₋ₓO₁₂ (0≤x≤3).

The oxide-based solid electrolyte may have a crystalline, amorphous, glassy, or glass-ceramic state. The sodium ion conductivity of the oxide-based solid electrolyte may be, for example, 1×10⁻⁵S/cm or more, 1×10⁻⁴S/cm or more, or 1×10⁻³S/cm or more at 25° C. and 1 atm. Sodium ion conductivity may be determined, for example, by impedance measurement.

Referring to FIGS. 6 and 7, the electrolyte 30 may include a binder in addition to the solid electrolyte. The binder of the electrolyte 30 may be the same as or different from the binder contained in the cathode 10 and the anode 20. The binder may be omitted.

The binder may be, but is not limited to, styrene butadiene rubber (SBR), polytetrafluoroethylene, polyvinylidene fluoride, or polyethylene, and any binder that may be used in the relevant technical field may be used. The content of the binder is, for example, about 0.1 wt % to about 10 wt %, about 0.1 wt % to about 5 wt %, about 0.1 wt % to about 3 wt %, or about 0.1 wt % to about 1 wt % with respect to the total weight of the solid electrolyte layer.

### [Cathode: Cathode Active Material]

Referring to FIGS. 6 and 7, the cathode active material layer 12 includes, for example, a cathode active material. The cathode active material may contain a cathode active material according to an embodiment.

The cathode active material may further contain at least one selected from a polyanionic compound and a prussian blue-based compound in addition to the cathode active material according to an embodiment.

The polyanionic compound may be, for example, a compound including sodium, a tetrahedral (YO₄)ⁿ⁻ anion unit, a polyhedral (ZO_{y})^{m+} cation unit, and an optional halogen. Y includes, for example, P, S, Si or a combination thereof. n represents a valence state of (YO₄)ⁿ⁻, for example, 1 to 5. Z is a transition metal including Mn, Fe, Ni, Co, Cr, Cu, Ti, Zn, V, Zr, Ce, or a combination thereof. m represents a valence state of (ZO_{y})^{m+}, for example, 1 to 5. The halogen includes, for example, F, Cl, Br, or a combination thereof.

The polyanionic compound includes, for example, NaFePO₄, Na₃V₂(PO₄)₃, NaM′PO₄F (M′=V, Fe, Mn, Ni or a combination thereof), Na₃(VO_{y})₂(PO₄)₂F_{3-2y} (0≤y≤1), or a combination thereof.

The prussian blue-based compound may be, for example, a compound including sodium, a transition metal, and a cyanide unit (CN⁻). The transition metal include, for example, Mn, Fe, Ni, Co, Cr, Cu, Ti, Zn, V, Zr, Ce, or a combination thereof.

The prussian blue-based compound may be, for example, a compound including sodium, a first transition metal, a second transition metal, and a cyanide unit (CN⁻). The content of sodium is more than 0 and 2 or less, the contents of the first transition metal and the second transition metal are each more than 0 and 1 or less, the first transition metal and the second transition metal are each independently Ni, Cu, Fe, Mn, Co, Zn, or a combination thereof, and the content of the cyanide unit is 6.

It is also possible to use a compound having a coating layer added to the surface of the above-described compound, and it is also possible to use a mixture of the above-described compound and the compound having the coating layer. The coating layer added to the surface of the above-described compound includes a coating element compound, for example, an oxide of a coating element, a hydroxide of a coating element, an oxyhydroxide of a coating element, an oxycarbonate of a coating element, or a hydroxycarbonate of a coating element. The coating element included in the coating layer includes Mg, Al, Co, K, Na, Ca, Si, Ti, V, Sn, Ge, Ga, B, As, Zr, or a mixture thereof.

The content of the cathode active material included in the cathode active material layer 12 may be, for example, about 30 wt % to about 95 wt %, about 40 wt % to about 90 wt %, about 50 wt % to about 80 wt %, or about 50 wt % to about 70 wt % based on the total weight of the cathode active material layer 12.

When the content of the cathode active material is too low, the energy density of the solid secondary battery 1 may decrease.

### [Cathode: Electrolyte]

The cathode active material layer 12 may further include, for example, an electrolyte. The electrolyte may be a solid electrolyte, a liquid electrolyte, a gel electrolyte, or a combination thereof. The content of the electrolyte included in the cathode active material layer 12 may be, for example, about 1 wt % to about 40 wt %, about 5 wt % to about 40 wt %, about 10 wt % to about 40 wt %, or about 20 wt % to about 40 wt % based on the total weight of the cathode active material layer 12.

### [Cathode: Conductive Material]

The cathode active material layer 12 may further include a conductive material. The conductive material may be, for example, a carbon-based conductive material, a metal-based conductive material, or a combination thereof. The carbon-based conductive material may be, but is not limited to, graphite, carbon black, acetylene black, Ketjen black, carbon fiber, or a combination thereof, and any material used as a carbon-based conductive material in the relevant technical field may be used. The metal-based conductive material may be, but is not limited to, metal powder, metal fiber, or a combination thereof, and any material used as a metal-based conductive material in the relevant technical field may be used. The content of the conductive material included in the cathode active material layer 12 may be, for example, about 1 wt % to about 30 wt %, about 1 wt % to about 20 wt %, or about 1 wt % to about 10 wt % based on the total weight of the cathode active material layer 12. The conductive material may be omitted.

The cathode active material layer 12 may further include a binder. The binder may be, but is not limited to, styrene butadiene rubber (SBR), polytetrafluoroethylene, polyvinylidene fluoride, or polyethylene, and any binder used in the relevant technical field may be used. The content of the binder included in the cathode active material layer 12 may be, for example, 1 wt % to 10 wt %, or 1 wt % to 5 wt % based on the total weight of the cathode active material layer 12. The binder may be omitted.

The cathode active material layer 12 may further include additives such as a filler, a coating agent, a dispersant, and an ion conductive aid in addition to the cathode active material, solid electrolyte, binder, and conductive material described above.

As the filler, coating agent, dispersant, and ion conductive aid that may be included in the cathode active material layer 12, known materials generally used in the electrode of the sodium solid secondary battery 1 may be used.

### [Cathode: Cathode Current Collector]

As the cathode current collector 11, a plate or foil made of indium (In), copper (Cu), magnesium (Mg), stainless steel, titanium (Ti), iron (Fe), cobalt (Co), nickel (Ni), zinc (Zn), aluminum (Al), germanium (Ge), sodium (Li), or an alloy thereof is used. The the cathode current collector 11 may be omitted. The thickness of the cathode current collector 11 is, for example, about 1 μm to about 100 μm, about 1 μm to about 50 μm, about 5 μm to about 25 μm, or about 10 μm to about 20 μm.

Referring to FIGS. 6 and 7, the anode 20 may be a deposited anode. In the solid secondary battery 1 including a deposited anode, a sodium metal layer may be additionally deposited between the anode active material layer 22 and the anode current collector 21 by charging. In the solid secondary battery 1 including a deposited anode, the sodium source of the anode 20 may be omitted, so the energy density of the solid secondary battery 1 may be further improved.

Referring to FIGS. 6 and 7, the anode 20 includes an anode active material layer 22. The anode active material layer 22 includes, for example, an anode active material and a binder.

The anode active material includes, for example, at least one selected from a carbon-based anode active material and a metal-based anode active material.

The carbon-based anode active material includes, for example, amorphous carbon, crystalline carbon, porous carbon, or a combination thereof.

The carbon-based anode active material is particularly amorphous carbon. Amorphous carbon is, but is not limited to, carbon black (CB), acetylene black (AB), furnace black (FB), ketjen black (KB), graphene, or the like, and any material classified as amorphous carbon in the relevant technical field may be used. Amorphous carbon is carbon that has no crystallinity or very low crystallinity, and is distinguished from crystalline carbon or graphite-based carbon.

The carbon-based anode active material may be, for example, porous carbon. The volume of pores included in the porous carbon is, for example, about 0.1 cc/g to about 10.0 cm³/g, about 0.5 cm³/g to about 5 cm³/g, or about 0.1 cm³/g to about 1 cm³/g. The average diameter of pores included in the porous carbon is, for example, about 1 nm to about 50 nm, about 1 nm to about 30 nm, or about 1 nm to about 10 nm. The BET surface area of the porous carbon is, for example, about 100 m²/g to about 3000 m²/g.

The metal-based anode active material includes, but is not necessarily limited to, gold (Au), tin (Sn), titanium (Ti), zinc (Zn), platinum (Pt), silicon (Si), silver (Ag), bismuth (Bi), germanium (Ge), lead (Pb), antimony (Sb), indium (In), lithium (Li), potassium (K), gallium (Ga), or a combination thereof, and any metal-based anode active material that forms an alloy or compound with sodium in the relevant technical field may be used. For example, Because nickel (Ni) does not form an alloy with sodium, nickel (Ni) is not a metal-based anode active material.

The anode active material layer 22 includes a type of anode active material among these anode active materials or a mixture of a plurality of different anode active materials. For example, the anode active material layer 22 may include only amorphous carbon, or may include gold (Au), tin (Sn), titanium (Ti), zinc (Zn), platinum (Pt), silicon (Si), silver (Ag), indium (In), lithium (Li), potassium (K), gallium (Ga), or a combination thereof. Alternatively, the anode active material layer 22 includes a mixture of amorphous carbon and at least one selected from gold (Au), tin (Sn), titanium (Ti), zinc (Zn), platinum (Pt), silicon (Si), silver (Ag), indium (In), lithium (Li), potassium (K), gallium (Ga), or a combination thereof. The mixing ratio of the mixture of amorphous carbon and gold or the like is, for example, about 99:1 to about 1:99, about 10:1 to about 1:2, about 5:1 to about 1:1, or about 4:1 to about 2:1 by weight ratio, but is not necessarily limited to this range and is selected according to the required characteristics of the sodium solid secondary battery 1. Because the anode active material has such a composition, the cycle characteristics of the sodium solid secondary battery 1 are further improved.

The anode active material layer 22 includes an anode active material, and the anode active material includes, for example, a mixture of first particles made of amorphous carbon and second particles made of metal. The metal includes, for example, gold (Au), tin (Sn), titanium (Ti), zinc (Zn), platinum (Pt), silicon (Si), silver (Ag), bismuth (Bi), germanium (Ge), lead (Pb), antimony (Sb), indium (In), lithium (Li), potassium (K), gallium (Ga), and the like. The content of the second particles is 1 wt % to 99 wt %, 1 wt % to 60 wt %, 8 wt % to 60 wt %, 10 wt % to 50 wt %, 15 wt % to 40 wt %, or 20 wt % to 30 wt % based on the total weight of the mixture. When the content of the second particles is within this range, the cycle characteristics of the sodium solid secondary battery 1 are further improved.

The anode active material has, for example, a particle form. The average particle diameter of the anode active material having a particle form is, for example, 4 μm or less, 3 μm or less, 2 μm or less, 1 μm or less, 500 nm or less, 300 nm or less, or 100 nm or less. The average particle diameter of the anode active material having a particle form is, for example, about 10 nm to about 4 μm, about 10 nm to about 3 μm, about 10 nm to about 2 μm, about 10 nm to about 1 μm, about 10 nm to about 500 nm, about 10 nm to about 300 nm, or about 10 nm to about 100 nm. Because the anode active material has an average particle diameter within this range, reversible absorption and/or desorption of sodium may be facilitated during charge and discharge. The average particle diameter of the anode active material is, for example, a median diameter (D50) measured using a laser particle size distribution meter.

The binder included in the anode active material layer 22 may be, but is not necessarily limited to, styrene-butadiene rubber (SBR), polytetrafluoroethylene, polyvinylidene fluoride, polyethylene, vinylidene fluoride/hexafluoropropylene copolymer, polyacrylonitrile, or polymethyl methacrylate, and any binder used in the relevant technical field may be used. The binder may consist of a single binder or a plurality of different binders.

Because the anode active material layer 22 includes a binder, the anode active material layer 22 is stabilized on the anode current collector 21. In addition, cracks in the anode active material layer 22 are suppressed despite changes in the volume and/or relative position of the anode active material layer 22 during a charge-discharge process. For example, when the anode active material layer 22 does not include a binder, it is possible for the anode active material layer 22 to be easily separated from the anode current collector 21. As the anode active material layer 22 is detached from the anode current collector 21, the possibility of occurrence of a short circuit increases at the exposed portion of the anode current collector 21 due to the contact of the anode current collector 21 with the electrolyte 30. The anode active material layer 22 is formed by applying a slurry, in which a material constituting the anode active material layer 22 is dispersed, onto the anode current collector 21 and drying the slurry. Stable dispersion of the anode active material in the slurry is possible by including a binder in the anode active material layer 22. For example, when applying the slurry onto the anode current collector 21 by screen printing, it is possible to suppress the clogging of a screen (for example, clogging of the anode active material by aggregates).

The anode active material layer 22 may further include additives used in the conventional sodium solid secondary battery 1, such as a filler, a coating agent, a dispersant, and an ion conductive aid.

The thickness of the anode active material layer 22 is, for example, 50% or less, 40% or less, 30% or less, 20% or less, 10% or less, or 5% or less of the thickness of the cathode active material layer 12. The thickness of the anode active material layer 22 is, for example, about 1% to about 50%, about 1% to about 40%, about 1% to about 30%, about 1% to about 20%, about 1% to about 10%, or about 1% to about 5% of the thickness of the cathode active material layer 12. The thickness of the anode active material layer 22 is, for example, about 1 μm to about 20 μm, about 2 μm to about 15 μm, or about 3 μm to about 10 μm. When the thickness of the anode active material layer 22 decreases excessively, sodium dendrites formed between the anode active material layer 22 and the anode current collector 21 collapse the anode active material layer 22, thereby making it difficult to improve the cycle characteristics of the sodium solid secondary battery 1. When the thickness of the negative electrode active material layer 22 increases excessively, the energy density of the sodium solid secondary battery 1 decreases, and the internal resistance of the sodium solid secondary battery 1 increases due to the anode active material layer 22 increases, thereby making it difficult to improve the cycle characteristics of the sodium solid secondary battery 1. When the thickness of the anode active material layer 22 decreases, for example, the initial charge capacity of the anode active material layer 22 also decreases.

### [Anode (I): Metal Layer]

Referring to FIG. 7, following a charge of a sodium solid secondary battery 1 of FIG. 7, the battery further includes a metal layer 23 disposed between the anode current collector 21 and the anode active material layer 22. The metal layer 23 is a metal layer containing a sodium metal or a sodium alloy. Therefore, the metal layer 23 may act or function as a sodium reservoir. The sodium alloy includes, but is not limited to, a Na—Sn alloy, a Na—In alloy, a Na—Ag alloy, a Na—Au alloy, a Na—Zn alloy, a Na—Ge alloy, or a Na—Si alloy, or any sodium alloy used in the relevant technical field may be used. The metal layer (23) may be made of one of these alloys, or sodium, or may be made of several types of alloys. The metal layer 23 is, for example, a plated layer. The metal layer 23 is deposited between the anode active material layer 22 and the anode current collector 21 during the charging process of the sodium solid secondary battery 1.

The thickness of the metal layer 23 is, but is not particularly limited, for example, about 1 micrometer (μm) to about 500 μm, about 1 μm to about 200 μm, about 1 μm to about 150 μm, about 1 μm to about 100 μm, or about 1 μm to about 50 μm. When the thickness of the metal layer 23 is too thin, it is difficult for the metal layer 23 to perform the role of a sodium reservoir. When the thickness of the metal layer 23 becomes too thick, the mass and volume of the sodium solid secondary battery 1 may increase too much, and as a result, the cycle characteristics of the sodium solid secondary battery 1 may deteriorate or decrease over time, e.g., extended charge cycles.

Alternatively, in the sodium solid secondary battery 1, the metal layer 23 may be disposed between the anode current collector 21 and the anode active material layer 22 during the assembly of the sodium solid secondary battery 1. When the metal layer 23 is disposed between the anode current collector 21 and the anode active material layer 22 in such a manner the sodium solid secondary battery 1, the metal layer 23 acts as a sodium reservoir because it is a metal layer containing sodium. For example, a sodium foil may be disposed between the anode current collector 21 and the anode active material layer 22 during the assembly of the sodium solid secondary battery 1.

When the metal layer 23 is deposited by charging, i.e., after assembling the sodium solid secondary battery 1, the energy density of the sodium solid secondary battery 1 increases because the metal layer 23 is not included during the assembly of the sodium solid secondary battery 1. When charging the sodium solid secondary battery, the charging is performed in excess of the charging capacity of the anode active material layer 22. That is, the anode active material layer 22 is overcharged. During the initial charging, sodium is absorbed into the anode active material layer 22. The anode active material included in the anode active material layer 22 forms an alloy or compound with sodium ions that have moved from the cathode 10. For example, when the charging is performed in excess of the charging capacity of the anode active material layer 22, sodium may deposit on a rear surface of the anode active material layer 22, that is, between the anode current collector 21 and the anode active material layer 22, and the metal layer 23 is formed by the deposited sodium.

The metal layer 23 is a metal layer mainly composed of sodium (that is, metal sodium). This result is obtained, for example, because the anode active material included in the anode active material layer 22 includes a material that forms an alloy or compound with sodium. During discharge, sodium in the anode active material layer 22 and the metal layer 23, that is, sodium in the metal layer is ionized and moves toward the cathode 10. It is possible to use sodium as an anode active material in the sodium solid secondary battery 1.

In addition, because the anode active material layer 22 covers the metal layer 23, the anode active material layer 22 may also act or function as a protective layer for the metal layer 23, and thereby, suppress or minimize the deposition and growth of sodium dendrites. The anode active material layer 22 may suppress or minimize short circuits, and improve upon the capacity of the sodium solid secondary battery 1, or other life-cycle characteristics of the sodium solid secondary battery 1. When the metal layer 23 is disposed by charging after assembling the sodium solid secondary battery 1, the anode 20, that is, the anode current collector 21 and the anode active material layer 22 and the region therebetween are Na-free regions that do not contain sodium (Na) in the initial state or in the state after complete discharge of the sodium solid secondary battery 1.

### [Anode (I): Anode Current Collector]

The anode current collector 21 is composed of a material that does not react with sodium, that is, a material that does not form either an alloy and/or a compound with sodium. The material of the anode current collector 21 includes, but is not necessarily limited to, indium (In), copper (Cu), stainless steel, titanium (Ti), iron (Fe), cobalt (Co), or nickel (Ni), or any material used as an electrode current collector in the relevant technical field may be used. The anode current collector 21 may be composed of one of the above-described metals, or may be composed of an alloy or coating material of two or more of the above-described metals. The anode current collector 21 is, for example, in the form of a plate or foil.

Although not shown in the drawings, the sodium solid secondary battery 1 may further include, for example, a thin film including a third metal capable of forming an alloy with sodium between the anode current collector 21 and the anode active material layer 22. The thin film may be disposed on one side of the anode current collector 21. The third metal may include, but is not necessarily limited to, gold (Au), tin (Sn), titanium (Ti), zinc (Zn), platinum (Pt), silicon (Si), silver (Ag), bismuth (Bi), germanium (Ge), lead (Pb), antimony (Sb), or a combination thereof, or any element capable of forming an alloy with sodium in the art may be used. The thin film may be composed of one of these metals or composed of an alloy of several types of metals. Because the thin film is disposed between the anode current collector 21 and the anode active material layer 22, the deposition shape of the metal layer 23 deposited between the thin film and the anode active material layer 22 may become flatter, and the cycle characteristics of the sodium solid secondary battery 1 may be further improved.

The thickness of the thin film is, for example, about 1 nanometer (nm) to about 800 nm, about 10 nm to about 700 nm, about 50 nm to about 600 nm, or about 100 nm to about 500 nm. When the thickness of the thin film is less than 1 nm, it may be difficult for the thin film to perform its function. When the thickness of the thin film is too thick, the thin film itself absorbs sodium, which reduces the amount of sodium deposited from the anode, thereby lowering the energy density of an all-solid-state battery and deteriorating the cycle characteristics of the sodium solid secondary battery 1. The thin film may be formed on the cathode current collector 21 by a vacuum deposition method, a sputtering method, a plating method, or the like, but the disclosure is not necessarily limited to these methods, and any method capable of forming a thin film in the relevant technical field is possible.

### [Anode (I): Anodelss]

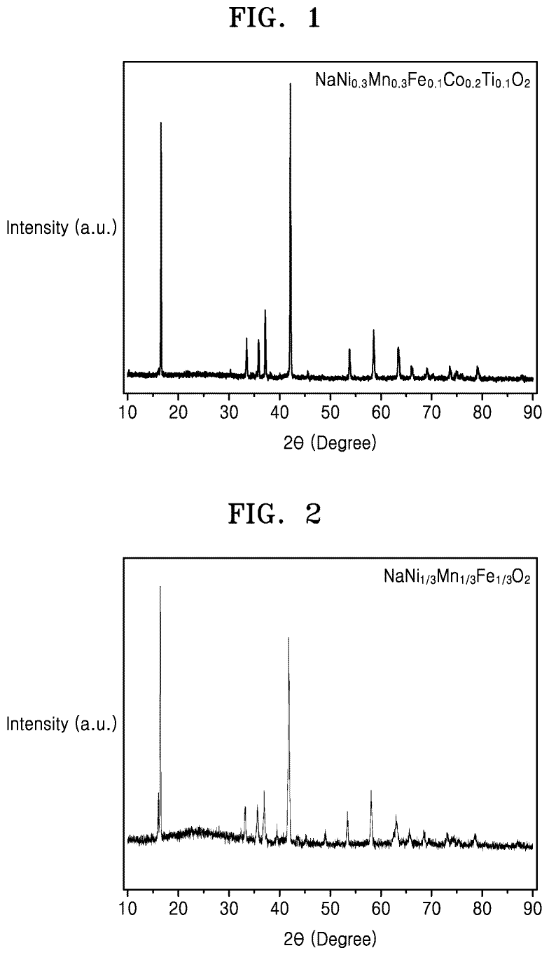

Referring to FIG. 6, the anode 20 includes only an anode current collector 21, and an anode active material layer may be omitted. An anode active material layer 22 is deposited between the electrolyte 30 and the anode current collector 21 following a charging of the sodium solid secondary battery 1. The anode active material layer 22 may be a sodium metal layer or a sodium alloy layer. The sodium solid secondary battery 1 after charging includes the anode active material layer 22 as shown in FIG. 1, and the anode active material layer 22 is the above-described sodium metal layer or sodium alloy layer.

Because the anode 20 includes only the anode current collector 21, the energy density of the sodium solid secondary battery 1 may be further improved

### [Anode (II): Non-Deposited Anode]

The anode may be a non-deposited anode. In the non-deposited anode, sodium is absorbed into the anode active material layer of the solid secondary battery by charging, and a sodium metal layer may not be additionally deposited between the anode active material layer and the anode current collector. In a solid secondary battery including the non-deposited anode, the lifespan performance of the solid secondary battery may be further improved because a volume change in the anode is alleviated or minimized during charge and discharge cycles.

### [Anode (II): Anode Active Material]

The anode active material layer may include an anode active material, a conductive material, and a binder. The contents of the anode active material, conductive material, and binder used in the anode active material layer are at levels typically used in the sodium solid secondary battery. Depending on the purpose and configuration of the sodium solid secondary battery, at least one of the conductive material and binder may be omitted.

The anode active material may include, but is not limited to, a metal-based anode active material, for example, Na, Sn, Bi, Zn, Sn—Cu alloy, or Bi—Cu alloy; a carbon-based anode active material such as hard carbon or soft carbon, an oxide-based anode active material containing Ti and/or Nb, or a combination thereof, or any anode active material used in the relevant technical field may be used.

The oxide-based anode active material containing Ti and/or Nb has high safety. For example, an oxide-based anode active material containing a crystal phase represented by Na₄TiO(PO₄)₂, Na₅Ti(PO₄)₃ having a redox potential of 1.5 V (vs. Na/Na+) or less accompanying charging and discharging may be used.

The content of the anode active material may be about 50 wt % to about 99 wt %, or about 60 wt % to about 90 wt %, based on the total weight of the negative electrode active material layer.

### [Anode (II): Binder]

The binder included in the anode active material layer may be selected from the above-described binders used in the deposited anode. The binder may include, but are not limited to, vinylidene a fluoride/hexafluoropropylene copolymer, polyvinylidene fluoride, polyacrylonitrile, polymethyl methacrylate, polytetrafluoroethylene (PTFE), a mixture of the above polymers, a styrene butadiene rubber-based polymer, polyacrylic acid, sodium-substituted polyacrylic acid, polyamideimide, or polyimide, or any combination thereof, or any binder used in the relevant technical field may be used.

The content of the binder may be about 0.1 wt % to about 10 wt %, about 0.1 wt % to about 5 wt %, or about 0.1 wt % to about 3 wt %. based on the total weight of the anode active material layer.

### [Anode (II): Conductive Material]

The anode active material layer may further include a conductive material. The conductive material may include a fibrous conductive material, a particulate conductive material, or a combination thereof. The conductive material may include, but is not limited to, graphite, carbon black, acetylene black, Ketjen black, carbon fiber, carbon nanotube, carbon nanofiber, or metal powder, and any conductive material used in the relevant technical field may be used. The conductive material may be omitted.

The content of the conductive material may be about 0.1 wt % to about 10 wt %, about 0.1 wt % to about 5 wt %, or about 0.1 wt % to about 2 wt %, based on the total weight of the anode active material layer.

### [Anode (II): Anode Active Material Layer]

A capacity ratio (B/A) of the initial charge capacity (B) of the anode active material layer and the initial charge capacity (A) of the cathode active material layer is, for example, 1 or more. The initial charge capacity of the cathode active material layer and the initial charge capacity of the anode active material layer may be measured by using the same method as in the above-described deposited anode. The capacity ratio (B/A) of the initial charge capacity (B) of the anode active material layer and the initial charge capacity (A) of the cathode active material layer is, for example, about 1.0 to about 1.3, about 1.0 to about 1.2, about 1.0 to about 1.1, or about 1.01 to about 1.1. The initial charge capacity (B) of the anode active material layer may be greater than the initial charge capacity (A) of the cathode active material layer. Because the initial charge capacity (B) of the anode active material layer is greater than the initial charge capacity (A) of the cathode active material layer, the deposition of sodium metal can suppressed or minimized, and the growth of sodium dendrites may be suppressed or minimized.

The anode current collector may be selected from the above-described anode current collectors used in the deposited anode.

Hereinafter, the present inventive concept will be described in detail with reference to examples and comparative examples. However, these examples are intended to illustrate the present inventive concept, and the scope of the present inventive concept is not limited thereto.

### Preparation of Cathode Active Material

### Example 1

Na₂CO₃, NiO, MnO₂, Fe₂O₃, CoO, and TiO₂ were weighed in a molar ratio of 0.5:0.3:0.3:0.05:0.2:0.1, and then milled at 300 rpm for 10 hours to obtain a precursor mixture. The precursor mixture was heat-treated in an air atmosphere at 950° C. for 12 hours to prepare a cathode active material (NaNi_{0.3}Mn_{0.3}Fe_{0.1}Co_{0.2}Ti_{0.1}O₂).

### Example 2

A cathode active material (NaNi_{0.3}Mn_{0.3}Co_{0.3}Ti_{0.1}O₂) was prepared in the same manner as in Example 1, except that the contents of Na₂CO₃, NiO, MnO₂, CoO, and TiO₂ were changed to a molar ratio of 0.5:0.3:0.3:0.3:0.1 in the preparation of the precursor mixture.

### Example 3

A cathode active material (NaNi_{0.4}Mn_{0.4}Fe_{0.05}Co_{0.1}Ti_{0.05}O₂) was prepared in the same manner as in Example 1, except that the contents of Na₂CO₃, NiO, MnO₂, Fe₂O₃, CoO, and TiO₂ were changed to a molar ratio of 0.5:0.4:0.4:0.025:0.1:0.05 in the preparation of the precursor mixture.

### Comparative Example 1: Neither Co nor Ti included

Na₂CO₃, NiO, MnO₂, and Fe₂O₃ were weighed in a molar ratio of 0.5:0.4:0.4:0.025:0.1:0.05, and then milled at 300 rpm for 10 hours to obtain a precursor mixture. The precursor mixture was heat-treated in an air atmosphere at 950° C. for 12 hours to prepare a cathode active material (NaNi_{1/3}Mn_{1/3}Fe_{1/3}O₂).

### Comparative Example 2: Neither Co Nor Ti Included

Na₂CO₃, NiO, MnO₂, and Fe₂O₃ were weighed in a mixing molar ratio of 0.5:1/3:1/3:1/6, and then milled at 300 rpm for 10 hours to obtain a precursor mixture. The precursor mixture was heat-treated in an air atmosphere at 950° C. for 12 hours to prepare a cathode active material (NaNi_{0.3}Mn_{0.5}Fe_{0.2}O₂).

### Comparative Example 3: Fe Content More than 10 Mol %, Co Included & Ti Non-Included

A cathode active material (NaNi_{0.4}Mn_{0.3}Fe_{0.15}Co_{0.15}O₂) was prepared in the same manner as in Example 1, except that the contents of Na₂CO₃, NiO, MnO₂, Fe₂O₃, and CoO were changed to a molar ratio of 0.5:0.4:0.3:0.075:0.15, in the preparation of the precursor mixture.

### Comparative Example 4: Fe Content More than 10 Mol %, Co Non-Included & Ti Included

A cathode active material (NaNi_{0.4}Mn_{0.3}Fe_{0.15}Ti_{0.15}O₂) was prepared in the same manner as in Example 1, except that the contents of Na₂CO₃, NiO, MnO₂, Fe₂O₃, and TiO₂ were changed to a molar ratio of 0.5:0.4:0.3:0.075:0.15, in the preparation of the precursor mixture.

### Comparative Example 5: Co Content<Ti Content

A cathode active material (NaNi_{0.3}Mn_{0.3}Fe_{0.1}Co_{0.1}Ti_{0.2}O₂) was prepared in the same manner as in Example 1, except that the contents of Na₂CO₃, NiO, MnO₂, Fe₂O₃, CoO, and TiO₂ were changed to a molar ratio of 0.5:0.3:0.3:0.05:0.1:0.2, in the preparation of the precursor mixture.

### Comparative Example 6: Mn Content Less than 30 Mol %

A cathode active material (NaNi_{0.4}Mn_{0.2}Fe_{0.1}Co_{0.2}Ti_{0.1}O₂) was prepared in the same manner as in Example 1, except that the contents of Na₂CO₃, NiO, MnO₂, Fe₂O₃, CoO, and TiO₂ were changed to a molar ratio of 0.5:0.4:0.2:0.05:0.2:0.1, in the preparation of the precursor mixture.

### Comparative Example 7: Ni and Mn Contents Less than 30 Mol % & (Co Content=Ti Content)

A cathode active material (NaNi_{0.2}Mn_{0.2}Fe_{0.2}Co_{0.2}Ti_{0.2}O₂) was prepared in the same manner as in Example 1, except that the contents of Na₂CO₃, NiO, MnO₂, Fe₂O₃, CoO, and TiO₂ were changed to a molar ratio of 0.5:0.2:0.2:0.1:0.2:0.2, in the preparation of the precursor mixture.

### Comparative Example 8: (Co Content=Ti Content) & Mg Included

A cathode active material (NaNi_{0.3}Mn_{0.3}Fe_{0.1}Co_{0.1}Ti_{0.1}Mg_{0.1}O₂) was prepared in the same manner as in Example 1, except that MgO was further added, and the contents of Na₂CO₃, NiO, MnO₂, Fe₂O₃, CoO, TiO₂, and MgO were changed to a molar ratio of 0.5:0.3:0.3:0.1:0.05:0.1:0.1, in the preparation of the precursor mixture.

The content (molar ratio) of each element in the cathode active materials of Examples 1 to 3 and Comparative Examples 1 to 8 is shown in Table 1 below, and Table 1 below indicates whether each of the cathode active materials satisfies Condition 1 (see, definitions of indices a, b, and c) and/or Condition 2 (see, definitions of indices d and e) of Formula 1. If Condition 1 or Condition 2 is satisfied an ∘ is indicated, respectively. A dash in a row indicates that the element is not present.

Condition 1:0.3≤a≤0.4, 0.3≤b≤0.4, 0≤c≤0.1, and

Condition 2: d>0, e>0, d>e.

TABLE 1

| | Content (molar ratio) of each element | | | | | | | Con- | Con- |
|---|---|---|---|---|---|---|---|---|---|
| | Na | Ni | Mn | Fe | Co | Ti | Mg | dition | dition |
| Class. | x | a | b | c | d | e | — | 1 | 2 |
| Ex. 1 | 1 | 0.3 | 0.3 | 0.1 | 0.2 | 0.1 | — | ◯ | ◯ |
| Ex. 2 | 1 | 0.3 | 0.3 | — | 0.3 | 0.1 | — | ◯ | ◯ |
| Ex. 3 | 1 | 0.4 | 0.4 | 0.05 | 0.1 | 0.05 | — | ◯ | ◯ |
| Comp. | 1 | 1/3 | 1/3 | 1/3 | — | — | — | X | X |
| Ex. 1 | | | | | | | | | |
| Comp. | 1 | 0.3 | 0.5 | 0.2 | — | — | — | X | X |
| Ex. 2 | | | | | | | | | |
| Comp. | 1 | 0.4 | 0.3 | 0.15 | 0.15 | — | — | X | X |
| Ex. 3 | | | | | | | | | |
| Comp. | 1 | 0.4 | 0.3 | 0.15 | — | 0.15 | — | X | X |
| Ex. 4 | | | | | | | | | |
| Comp. | 1 | 0.3 | 0.3 | 0.1 | 0.1 | 0.2 | — | ◯ | X |
| Ex. 5 | | | | | | | | | |
| Comp. | 1 | 0.4 | 0.2 | 0.1 | 0.2 | 0.1 | — | X | ◯ |
| Ex. 6 | | | | | | | | | |
| Comp. | 1 | 0.2 | 0.2 | 0.2 | 0.2 | 0.2 | — | X | X |
| Ex. 7 | | | | | | | | | |
| Comp. | 1 | 0.3 | 0.3 | 0.1 | 0.1 | 0.1 | 0.1 | ◯ | X |
| Ex. 8 | | | | | | | | | |

### Manufacture Example 1

The cathode active material prepared in Example 1, Denka black as a conductive material, and polyvinylidene fluoride (PVdF) as a binder were mixed in a weight ratio of 80:10:10 with a sufficient amount of N-methylpyrrolidone (NMP) in an agate mortar to prepare a slurry. The slurry was applied onto a 15 μm thick aluminum current collector by bar coating, dried at room temperature (25° C.), dried a second time in a vacuum at 120° C., and then rolled and punched to manufacture a cathode.

Battery assembly was carried out in a glove box, and a 2032 type coin cell was manufactured by using a sodium foil as a counter electrode, using a glass fiber separator (Whatman GF/F CAT No. 1825-150), and using an electrolyte (0.5 M NaPF₆ in propylene carbonate (PC):fluoroethylene carbonate (FEC)=98:2 (volume ratio)).

### Manufacture Examples 2 and 3

Coin cells were manufactured in the same manner as in Manufacture Example 1, except that each of the cathode active materials prepared in Examples 2 and 3 were used instead of the cathode active material prepared in Example 1 when manufacturing the cathode.

### Comparative Manufacture Examples 1 to 8

Comparative coin cells were manufactured in the same manner as in Manufacture Example 1, except that the comparative cathode active materials prepared in Comparative Examples 1 to 8 were used, respectively, to provide the comparative cathode active material when manufacturing the cathode.

### Evaluation Example 1: XRD Evaluation

X-ray diffraction (XRD) experiments were performed on the cathode active materials prepared according to Example 1 and Comparative Example 1, and XRD analysis spectra are shown in FIGS. 1 and 2, respectively.

Referring to FIG. 1, the cathode active material of Example 1 has an intensity (Ia) of a peak at 2θ of 42° (first peak) that is greater than an intensity (Ib) of a peak at 2θ of 17° (second peak), and the intensity ratio (Ia/Ib) is 1:0.7 to 1:0.8 or 1:0.72 to 1:0.78.

In contrast, as shown in FIG. 2, the cathode active material of Comparative Example 1 has an intensity (Ib) of a peak at 2θ of 17° (second peak) that is greater than an intensity (Ia) of a peak at 2θ of 42° (first peak).

### Evaluation Example 2: Charge-Discharge Characteristics Test

Charge-discharge tests of coin cells using cathode active materials prepared in Examples 1 to 2 and Comparative Examples 1 to 5 were performed in a constant-temperature bath at room temperature (25° C.).

For each sodium secondary battery, the manufactured coin cell was charged to 4 V with a constant current of 0.1 C, and then constant voltage conditions were applied until end current reached 0.05 C (CC-CV). Then, the coin cell was discharged to 2.0 V with a constant current of 0.1 C to evaluate an initial capacity.

A capacity retention rate was evaluated in the same charge-discharge cycle conditions as those used to evaluate the initial capacity, except that a determining rate was changed to 0.2 C, and 50 cycles were performed.

The initial capacities (0.1 C capacity) and capacity retention rates of the coin cells of Manufacture Examples 1 to 3 are shown in Table 2, and the initial capacities (0.1 C capacity) of the coin cells of Comparative Manufacture Examples 1 to 8 are shown in Table 3.

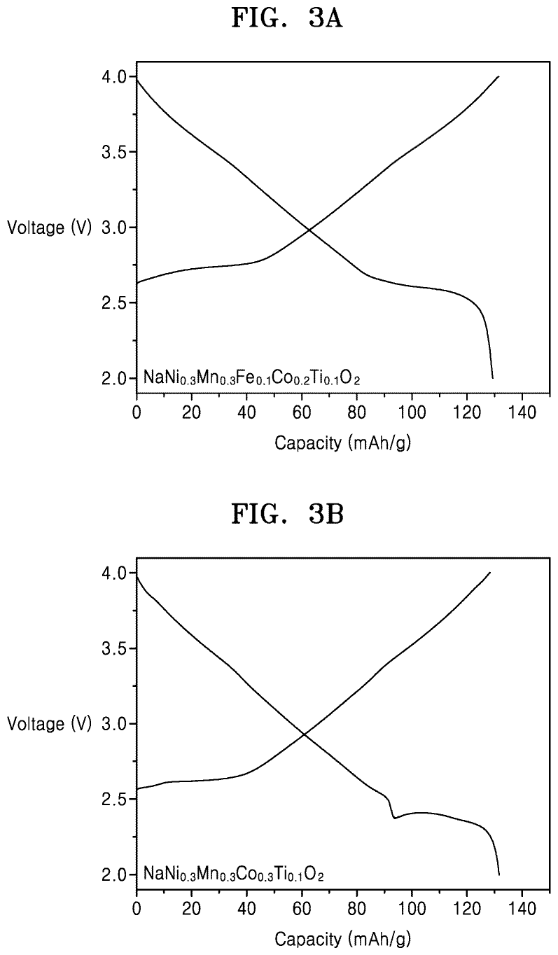

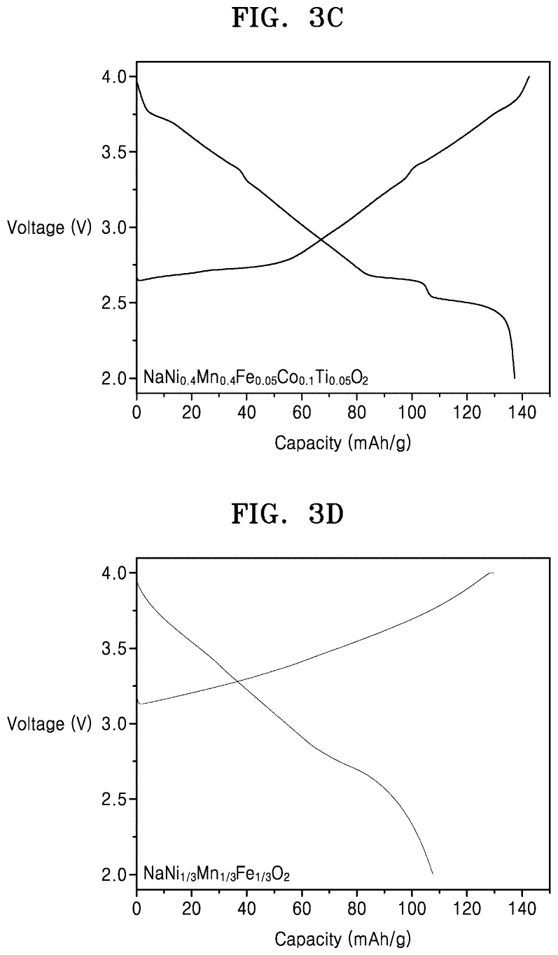

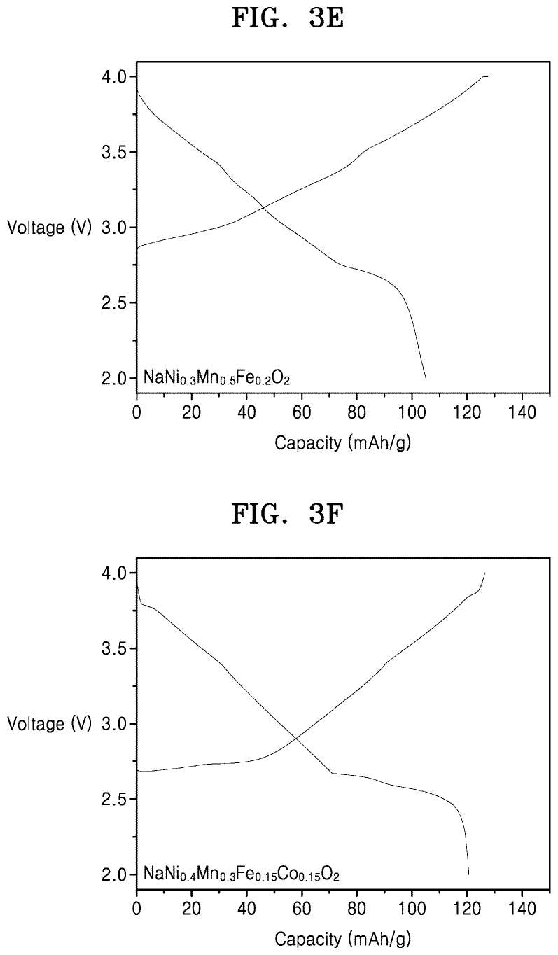

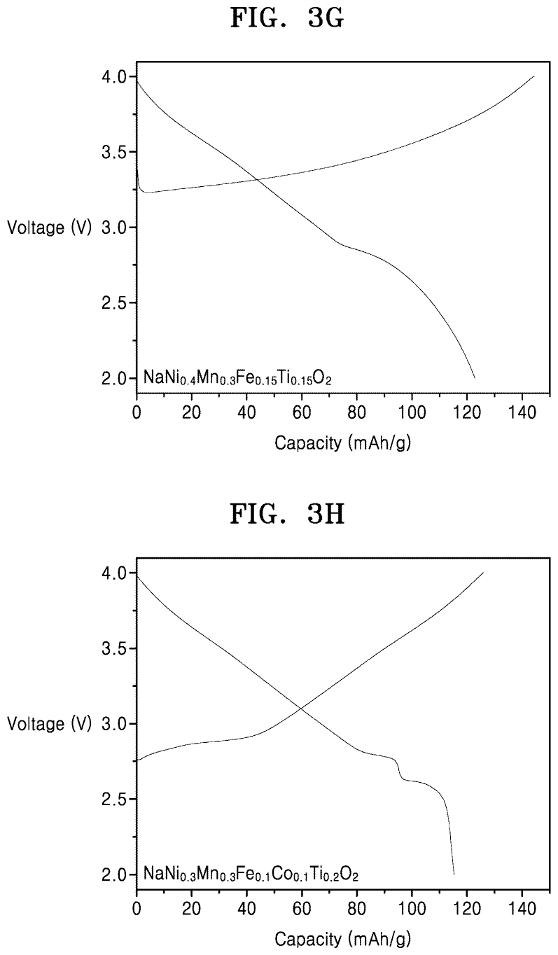

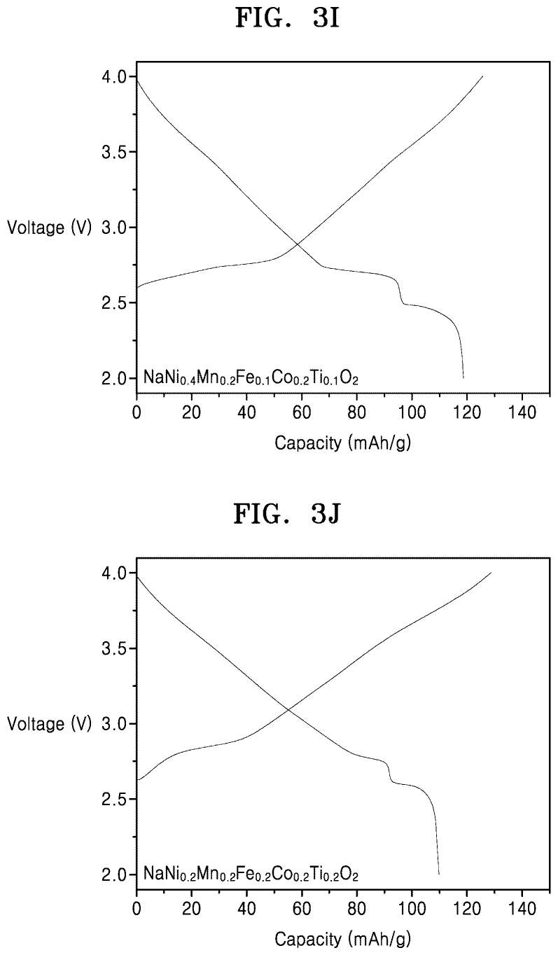

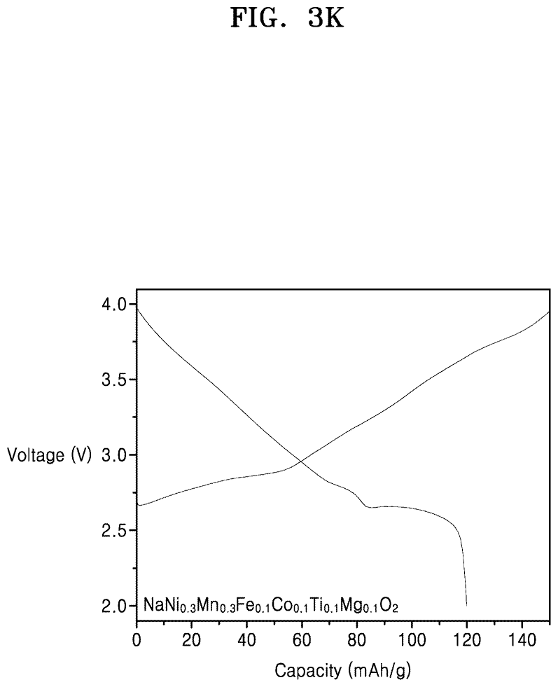

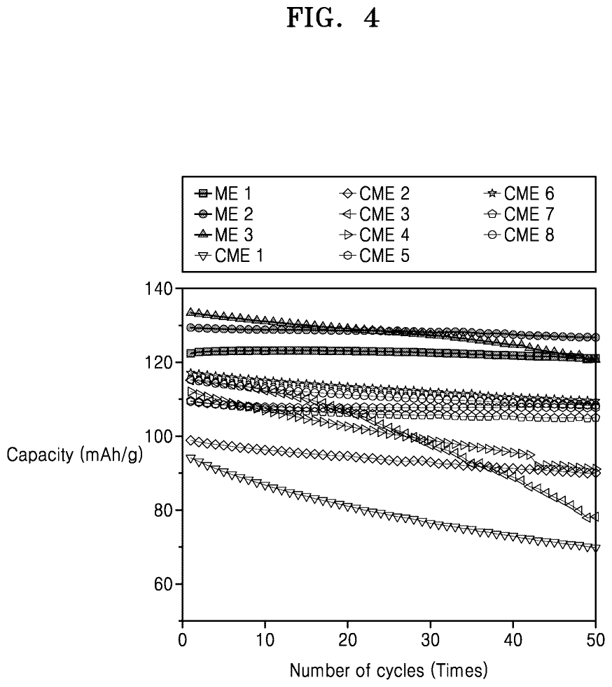

In addition, in the coin cells of Manufacture Examples 1 to 3 and Comparative of Manufacture Examples 1 to 8, the voltage changes according to the capacity are shown in FIGS. 3A to 3K, respectively, and the capacity retention characteristics thereof are shown in FIG. 4.

The capacity retention rate of the coin cell is expressed by Equation 1 below.

$$Capacity retention rate [ \% ] = [ discharge capacity at 50 th cycle / discharge capacity at 1 st cycle ] \times 100 \qquad Equation 1$$

TABLE 2

| | | | | | | | | Initial | Capacity |
|---|---|---|---|---|---|---|---|---|---|
| | | | | | | | | capacity | retention |
| | | | | | | | | (0.1C | rate (%) |
| | Content (molar ratio) of each element | | | | | | | capacity) | (0.2C, |
| Class. | Na | Ni | Mn | Fe | Co | Ti | Mg | (mAh) | 50 cycle) |
| Ex. 1 | 1 | 0.3 | 0.3 | 0.1 | 0.2 | 0.1 | — | 129.3 | 98.9 |
| Ex. 2 | 1 | 0.3 | 0.3 | | 0.3 | 0.1 | — | 131.6 | 98 |
| Ex. 3 | 1 | 0.4 | 0.4 | 0.05 | 0.1 | 0.05 | — | 137.7 | 90.4 |

TABLE 3

| | | | | | | | | Initial |
|---|---|---|---|---|---|---|---|---|
| | | | | | | | | capacity |
| | | | | | | | | (0.1C |
| | Content (molar ratio) of each element | | | | | | | capacity) |
| Class. | Na | Ni | Mn | Fe | Co | Ti | Mg | (mAh) |
| Comp. | 1 | 1/3 | 1/3 | 1/3 | — | — | — | 107.6 |
| Ex 1 | | | | | | | | |
| Comp. | 1 | 0.3 | 0.5 | 0.2 | — | — | — | 105.1 |
| Ex. 2 | | | | | | | | |
| Comp. | 1 | 0.4 | 0.3 | 0.15 | 0.15 | — | — | 120.6 |
| Ex. 3 | | | | | | | | |
| Comp. | 1 | 0.4 | 0.3 | 0.15 | | 0.15 | — | 122.8 |
| Ex. 4 | | | | | | | | |
| Comp. | 1 | 0.3 | 0.3 | 0.1 | 0.1 | 0.2 | — | 115.3 |
| Ex. 5 | | | | | | | | |
| Comp. | 1 | 0.4 | 0.2 | 0.1 | 0.2 | 0.1 | — | 118.7 |
| Ex. 6 | | | | | | | | |
| Comp. | 1 | 0.2 | 0.2 | 0.2 | 0.2 | 0.2 | — | 109.8 |
| Ex. 7 | | | | | | | | |
| Comp. | 1 | 0.3 | 0.3 | 0.1 | 0.1 | 0.1 | 0.1 | 119.9 |
| Ex. 8 | | | | | | | | |

Referring to Table 2 and Table 3, the coin cells of Manufacture Examples 1 to 3 using the cathode active materials of Examples 1 to 3 have superior initial capacities than the coin cells of Comparative Manufacture Examples 1 to 8 using the cathode active materials of Comparative Examples 1 to 8 (Table 3), which include cathode active materials containing both cobalt and titanium.

In addition, the coin cells of Manufacture Examples 1 to 3 exhibit excellent capacity retention rates, as shown in Table 2 and FIG. 4. In FIG. 4, ME denote Manufacture Examples, CME denotes Comparative Manufacture Example. In contrast, the capacity retention rates of the coin cells of Comparative Manufacture Examples 1, 3, and 4 are 74.2%, 67.9%, and 81.3%, respectively, which are lower than those of the coin cells of Manufacture Examples 1 to 3. Further, as shown in FIG. 4, the coin cells of Manufacture Examples 1 to 3 exhibit high capacity characteristics after 50 cycles compared to the coin cells of Comparative Manufacture Examples 1 to 8.

In addition, as shown in FIG. 4, the coin cell of Manufacture Example 3 not only has a large initial capacity compared to the coin cell of Comparative Manufacture Example 3, but also has a higher capacity after 50 cycles than that of Comparative Manufacture Example 3.

According to an aspect, a cathode active material for a sodium secondary battery with improved structural stability is provided, and a sodium secondary battery with excellent capacity and improved capacity retention characteristics may be provided when using the cathode active material as described herein.

As described above, embodiments have been described in detail with reference to the attached drawings, but the present inventive concept is not limited thereto. It is obvious that a person with ordinary knowledge in the technical field to which the present inventive concept belongs can derive various examples of changes or modifications within the scope of the technical idea described in the claims, and these also naturally fall within the technical scope of the present inventive concept.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A cathode active material for a sodium secondary battery, the cathode active material comprising a layered sodium transition metal oxide having an O3 structure, wherein the layered sodium transition metal oxide includes a compound represented by Formula 1: 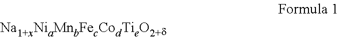
wherein, in Formula 1,
−0.33≤x≤0.1, 0.3≤a≤0.4, 0.3≤b≤0.4, 0≤c≤0.1, d>0, e>0, d>e, a+b+c+d+e=1, and −0.1≤δ≤0.1.

2. The cathode active material of claim 1,
wherein, in Formula 1, 0.1≤d≤0.3 and 0.05≤e≤0.1.

3. The cathode active material of claim 1,
wherein, in Formula 1, 1≤d/e≤3.

4. The cathode active material of claim 1,
wherein, in Formula 1, 0.05≤c≤0.1.

5. The cathode active material of claim 1,
wherein the cathode active material has an average particle diameter of about 1 μm to about 20 μm.

6. The cathode active material of claim 1,
wherein the cathode active material has a BET specific area of about 0.2 m²/g to about 5 m²/g, and
the cathode active material has a tap density of about 1.0 g/cm³ to about 3.5 g/cm³.

7. The cathode active material of claim 1,
wherein the cathode active material is NaNi_{0.3}Mn_{0.3}Fe_{0.1}Co_{0.2} Ti_{0.1}O₂, NaNi_{0.3}Mn_{0.3}Co_{0.3}Ti_{0.1}O₂, NaNi_{0.4}Mn_{0.4}Fe_{0.05}Co_{0.1}Ti_{0.05}O₂, NaNi_{0.4}Mn_{0.3}Co_{0.2}Ti_{0.1}O₂, or NaNi_{0.35}Mn_{0.35}Co_{0.2}Ti_{0.1}O₂.

8. The cathode active material of claim 1,
wherein, in a sodium secondary battery that includes a cathode including the cathode active material, a 0.1 C rate capacity of sodium metal in a voltage range of about 2.0 V to about 4.0 V is about 125 mAh/g to about 140 mAh/g, and a capacity retention rate is 90% or more after 50 charge-discharge cycles at a constant current of 0.1 C rate.

9. A sodium secondary battery comprising: a cathode; an anode; and an electrolyte between the cathode and the anode,
wherein the cathode includes a cathode current collector, and a cathode active material layer disposed on the cathode current collector and including a cathode active material, the cathode active material including a layered sodium transition metal oxide having an O3 structure, and the layered sodium transition metal oxide includes a compound represented by Formula 1: 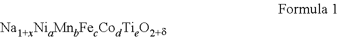
wherein, in Formula 1,
−0.33≤x≤0.1, 0.3≤a≤0.4, 0.3≤b≤0.4, 0≤c≤0.1, d>0, e>0, d>e, a+b+c+d+e=1, and −0.1≤8≤0.1.

10. The sodium secondary battery of claim 9,
wherein the electrolyte includes a solid electrolyte, a liquid electrolyte, a gel electrolyte, or a combination thereof.

11. The sodium secondary battery of claim 9, further comprising a separator.

12. The sodium secondary battery of claim 9,
wherein a 0.1 C rate capacity of sodium metal in a voltage range of about 2.0 V to about 4.0 V is about 125 milliampere per gram to about 140 milliampere per gram, and a capacity retention rate is 90% or more after 50 charge-discharge cycles at a constant current of 0.1 C rate.

13. The sodium secondary battery of claim 9,
wherein the anode includes: an anode current collector; and an anode active material layer disposed on the anode current collector, and
the anode active material layer includes an anode active material and a binder.

14. The sodium secondary battery of claim 13,
wherein the anode active material includes a carbon-based anode active material, a metal-based anode active material, or a combination thereof.

15. The sodium secondary battery of claim 14,
wherein the carbon-based anode active material includes amorphous carbon, crystalline carbon, porous carbon, or a combination thereof, and
the metal-based anode active material includes gold, platinum, palladium, silicon, silver, aluminum, bismuth, tin, zinc, indium, lithium, potassium, gallium, germanium, antimony, or a combination thereof.

16. The sodium secondary battery of claim 9,
wherein the anode includes an anode current collector, an anode active material layer disposed on the anode current collector, and a metal layer between the anode current collector and the anode active material layer,
wherein the metal layer includes sodium metal or a sodium alloy.

17. The sodium secondary battery of claim 9,
wherein the anode includes sodium metal, a sodium alloy, or a combination thereof.

18. A method of preparing a cathode active material for a sodium secondary battery, the method comprising:
mixing a sodium precursor, a nickel precursor, a manganese precursor, a cobalt precursor, and a titanium precursor to provide a precursor mixture; and
heat-treating the precursor mixture to prepare a cathode active material,
wherein the cathode active material includes a layered sodium transition metal oxide having an O3 structure, and the layered sodium transition metal oxide includes a compound represented by Formula 1: 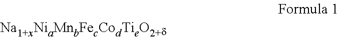
wherein, in Formula 1,
−0.33≤x≤0.1, 0.3≤a≤0.4, 0.3≤b≤0.4, 0≤c≤0.1, d>0, e>0, d>e, a+b+c+d+e=1, and −0.138≤0.1.

19. The method of claim 18,
wherein the mixing further comprises mixing an iron precursor to provide the precursor mixture.

20. The method of claim 18,
wherein the heat-treating of the precursor mixture is performed at about 600° C. to about 1,000° C.
